(19) United States
(12) Patent Application Publication
(10) Pub. No.: US 2024/0286621 A1
(43) Pub. Date: Aug. 29, 2024

(54) UPDATING MODEL OF ABNORMAL DRIVING DETECTION

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); TOMOHIRO MATSUDA, Mountain View, CA (US); YONGKANG LIU, Mountain View, CA (US); EMRAH AKIN SISBOT, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/175,255

(22) Filed: Feb. 27, 2023

(51) Int. Cl. B60W 50/00; G07C 5/04

(52) U.S. Cl. CPC B60W 50/0097; G07C 5/04

(57) ABSTRACT

Systems and methods are provided for programmatically determining an abnormal driving performed by a second vehicle. The systems and methods may, for example, receive first driving data from a sensor of the ego vehicle, the first driving data comprising a gap in time-series data entries of movements of the second vehicle; receive second driving data that fills in the gap in the time-series data entries of the second vehicle; aggregate the first driving data with the second driving data to aggregated driving data to generate metadata, the aggregated driving data comprising movements of the second vehicle that exceed a threshold value of predicted movements defined in a model of abnormal driving detection, and the metadata used to select the model of abnormal driving detection; and execute an algorithm that provides driving assistance for the ego vehicle in responding to the predicted movements defined in the model of abnormal driving detection.

### TECHNICAL FIELD

The present disclosure relates generally to responding to abnormal driving behavior. Particularly, some embodiments relate to systems and methods for identifying a model of abnormal driving detection that can help in defining a pattern of predicted operations, and executing a response that guides a driver or operates an autonomous vehicle to respond to the pattern of driving behavior detected.

### DESCRIPTION OF RELATED ART

Some driving systems analyze objects in a roadway in which the vehicle (e.g., the ego vehicle) is traveling. The objects may be moveable objects, like other vehicles and drivers, or immovable objects like traffic lights and stop signs. When another object is acting without regard to the expected procedure, the subject vehicle may determine that the object is an anomaly. The object may be an anomaly by performing actions that are done in an unusual time (e.g., relative to a typical time for a particular geographic location) or an unusual location (e.g., relative to a typical location). For example, another vehicle that is exhibiting anomalous behavior includes performing an unusual action that does not typically occur or infrequently occurs relative to the types of actions that are typical for a particular geographic location or situation. An occurrence of a vehicle exhibiting anomalous behavior in a roadway environment may jeopardize safety of various roadway participants (e.g., vehicles, drivers, passengers, pedestrians, bikers, etc.) and may reduce the overall efficiency of a transportation system.

### BRIEF SUMMARY OF THE DISCLOSURE

Anomaly detection in vehicles operating on a roadway is beneficial to improving safety on roadways, reducing injuries, and improving efficiency of operating vehicles in the environment. Some examples of abnormal driving may include aggressive driving (e.g., tailgating, cut-in lane, etc.), distracted driving (e.g., swerving, delayed reaction, etc.), and reckless driving (e.g., red light running, lane change without signaling, abrupt and frequent lane changes, excessive speed, etc.). A vehicle operating on the roadway may be equipped with anomaly detection (e.g., the ego vehicle) that determines predicted operations (e.g., from modeling in various driving situations or other predicted values, including predicted distance to a nearby other vehicle through sensors) that are generated from the sensor data to detect an identification of abnormal driving by other vehicles.

The predicted operations of other vehicles may be determined using various modeling processes. These modeling processes can include, for example, time-series modeling, supervised machine learning models and others that may be trained using data from multiple vehicles in multiple situations to predict particular types of abnormal driving operations of other vehicles, deep learning models (e.g., Convolutional Neural Networks (CNNs), Long Short Term Memory Networks (LSTMs), Recurrent Neural Networks (RNNs), etc.), linear regression model, or other modeling processes.

In order to execute these modeling processes, the models receive and are trained using driving data that correspond with a movement profile or model of abnormal driving behavior (used interchangeably) that can define a pattern of predicted operations of the other vehicle. Through this process, models can be trained to recognize driving scenarios that correspond to normal or abnormal driving situations.

Using the movement profile or model of abnormal driving behavior, the appropriate model can be selected to identify the type of abnormal driving and how the ego vehicle can respond to it. However, the collection of driving data with actual operations of the other vehicle may be interrupted due to lane change driving behavior of another long/large vehicle (or other obstruction), causing gaps in the time-series data entries collected by the ego vehicle. Traditional models may require consecutive collection of driving data. The ego vehicle suffers from learning the pattern of operations of the other vehicle and is unable to collect a threshold amount of driving data to provide to the system to select a model of abnormal driving behavior that can interpret, predict future movements of the second vehicle, and respond to operations of the other vehicle.

Second driving data may be received to fill in gaps using various methods. For example, the ego vehicle may sense the driving environment and construct second driving data locally, receive second driving data from a follower vehicle or preceding vehicle via a temporary network (e.g., peer-to-peer or vehicle-to-anything network), or receive second driving data from a remote server to fill in gaps in the time-series data entries. In some examples, first driving data is analyzed at the ego vehicle using a trained machine learning model to determine a predicted movement of the second vehicle corresponding with abnormal driving detection of a particular movement profile. In this example, ego vehicle uses the trained machine learning model to generate the second driving data that fills in the gaps in the time-series data entries, rather than a complete time-series based analysis of the movement of the second vehicle.

In another example, the ego vehicle can share the received/observed driving data or metadata with the anomaly managing system and the anomaly managing system analyzes the metadata. The metadata may correspond to a summarized and shortened form of the driving data, so that less data is transmitted via the network. For example, metadata may include driving data (e.g., generated by sensors of the ego vehicle or second vehicle), a set of parameters used in the abnormal driving detection (e.g., distance-to-collision, following distance, speed, etc.), a set of sensors used to measure the parameters of the subject vehicle (e.g., camera, lidar, radar, etc.), inferred or limited characteristics of a particular movement pattern, or the movement profile assigned to the vehicle.

Using the metadata, the anomaly managing system generates a suggestion for a trained machine learning model for the ego vehicle, where the model is used to predict the movement profile of other vehicles that may be operating abnormally. The abnormal operations of the other vehicles may correspond with abnormal driving (e.g., that follow driving patterns that has been detected previously) or movement profiles that can be identified using the model of abnormal driving detection. Since the driving data by the ego vehicle is interrupted, the anomaly managing system may implement the suggested model remotely from the ego vehicle with second driving data as output. The anomaly managing system may transmit the model of abnormal driving detection to the ego vehicle, which it can use to execute an algorithm to provide driving assistance to respond to the predicted movements defined in the movement profile.

ACCording to various embodiments of the disclosed technology, systems and methods are provided for the ego vehicle to programmatically determine a model of abnormal driving detection that corresponds with movements performed by a second vehicle. The systems and methods may, for example, receive driving data from a sensor of the ego vehicle, the driving data comprising a gap in time-series data entries of movements of the second vehicle; receive second driving data that fills in the gap in the time-series data entries of the second vehicle; aggregate the driving data with the second driving data that comprises movements of the second vehicle that exceed a threshold value of predicted movements defined in a movement profile; and execute an algorithm that provides driving assistance for the ego vehicle in responding to the predicted movements defined in the movement profile.

The threshold value comparison may be based on determining a set of contrast profiles that illustrate the difference between movement profiles that characterize the second vehicle's movement. The set of contrast profiles may be compared with the driving data collected by the ego vehicle, second vehicle, or remote server to determine predicted movements of vehicles that are matched to the movement profile in excess of the threshold value.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example vehicle architecture for implementing a verification process of the origin of abnormal driving in accordance with some embodiments of the systems and methods described herein.

FIG. 3 is a block diagram illustrating an architecture for the anomaly managing system and the anomaly managing client according to some embodiments.

FIG. 4 is a graphical representation of an example approach of model selection according to some embodiments.

FIG. 5 is a graphical representation illustrating movement patterns or movement profiles according to some embodiments.

FIG. 6 is a graphical representation illustrating movement profiles according to some embodiments.

FIG. 7 is a graphical representation illustrating gaps in driving data according to some embodiments.

FIG. 8 is a graphical representation illustrating gaps in driving data that can affect selection of an abnormal driving detection model based on movement patterns according to some embodiments.

FIG. 9 illustrates a process for programmatically updating pattern recognition leading to abnormal driving detection in accordance with some embodiments of the systems and methods described herein.

FIG. 10 is an example computing component that may be used to implement various features of embodiments described in the present disclosure.

The figures are not exhaustive and do not limit the present disclosure to the precise form disclosed.

### DETAILED DESCRIPTION

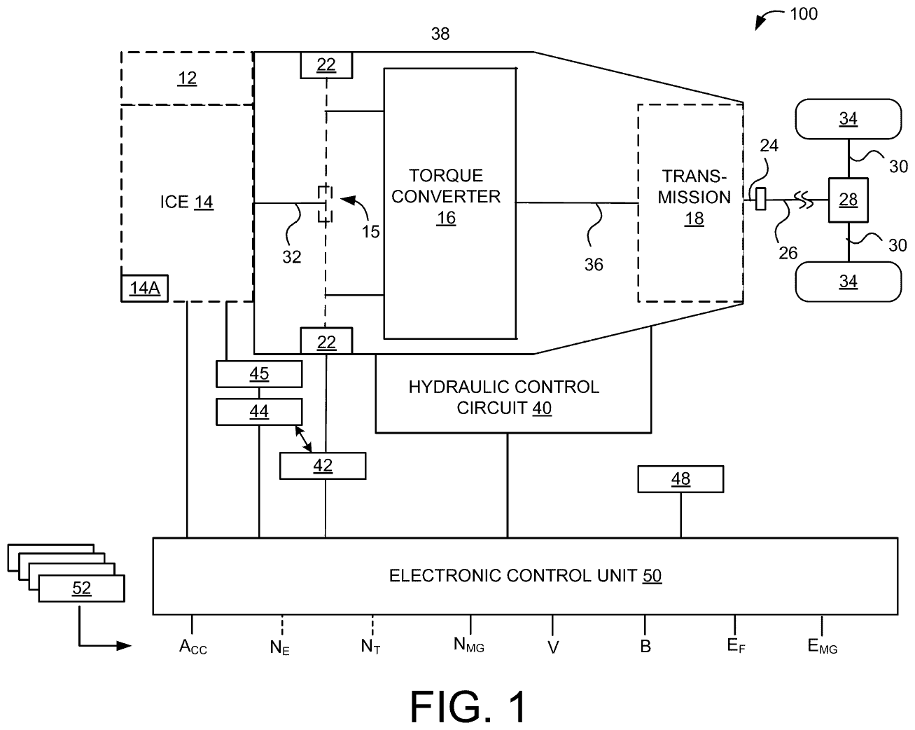

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for programmatically updating pattern recognition leading to abnormal driving detection can be implemented in other types of vehicles including gasoline- or diesel-powered vehicles, fuel-cell vehicles, electric vehicles, or other vehicles. Any of these vehicles may be implemented as a connected or non-connected vehicle.

FIG. 1 illustrates a drive system of vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and clutch 15 may be included to engage engine 14. In the EV travel mode, vehicle 100 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

Output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage battery charger 45. Battery 44 may also be charged by motor 22 such as, for example, by regenerative braking or by coasting during which time motor 22 operate as generator.

Motor 22 can be powered by battery 44 to generate a motive force to move vehicle 100 and adjust vehicle speed. Motor 22 can also function as a generator to generate electrical power such as, for example, when coasting or braking. Battery 44 may also be used to power other electrical or electronic systems in vehicle 100. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

Electronic control unit 50 (described below) may be included and may control the electric drive components of vehicle 100 as well as other vehicle components. For example, electronic control unit 50 may control inverter 42, adjust driving current supplied to motor 22, and adjust the current received from motor 22 during regenerative coasting and breaking. As a more particular example, output torque of motor 22 can be increased or decreased by electronic control unit 50 through inverter 42.

Torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of vehicle 100. In the illustrated example, crankshaft 32, which is an output member of engine 14, may be selectively coupled to motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated).

When clutch 15 is engaged, power transmission is provided in the power transmission path between crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of clutch 15.

As alluded to above, vehicle 100 may include electronic control unit 50. Electronic control unit 50 may include circuitry to control various aspects of the vehicle operation. Electronic control unit 50 may include, for example, a microcomputer that includes one or more processing units or processors (e.g., microprocessors), memory storage (e.g., RAM, ROM, etc.), and I/O devices. The processing units of electronic control unit 50, execute instructions stored in memory to control one or more electrical systems or subsystems in vehicle 100. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, NE, of internal combustion engine 14 (engine RPM), a rotational speed, N_{MG}, of motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more sensors 52 may include their own processing capability to compute the results for additional information that can be provided to electronic control unit 50. In other embodiments, one or more sensors 52 may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

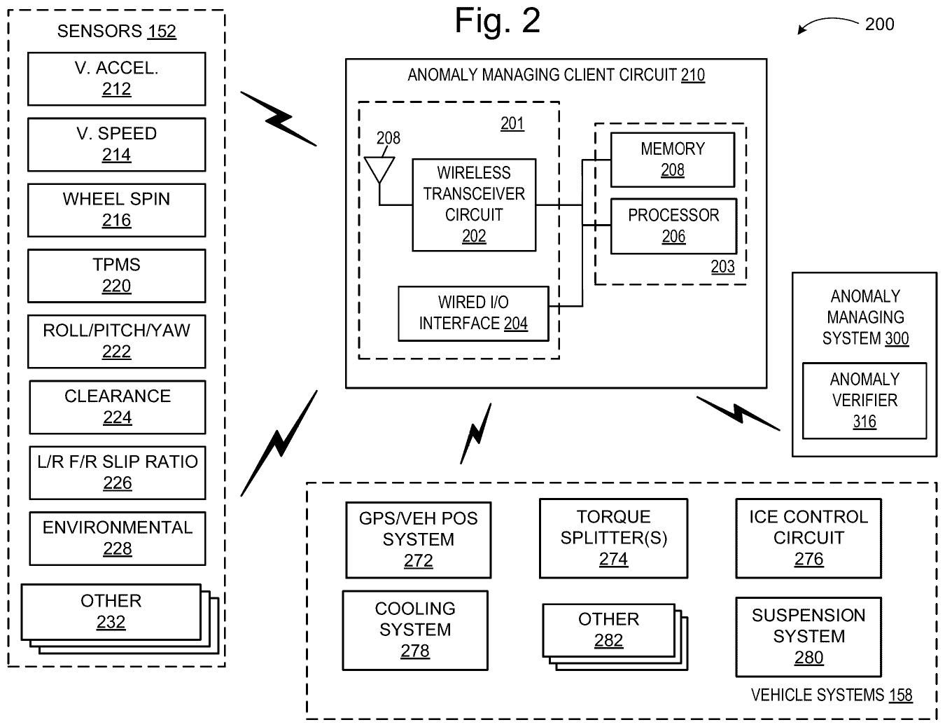

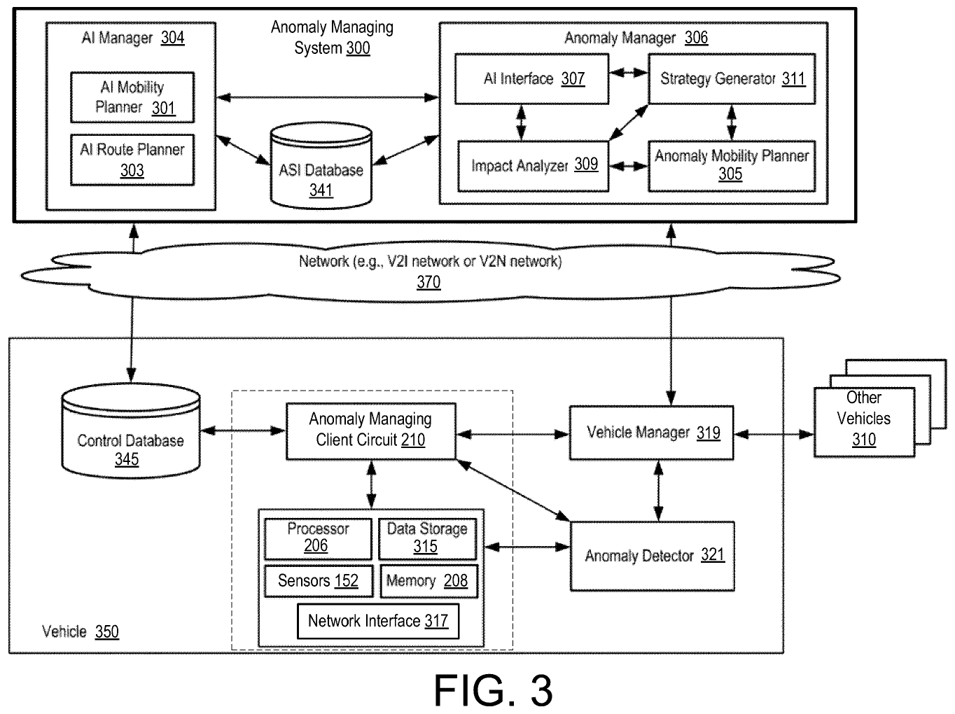

FIG. 2 illustrates an example vehicle architecture for implementing a verification process of the origin of abnormal driving in accordance with some embodiments of the systems and methods described herein. In this example, vehicle 200 includes anomaly managing client circuit 210, sensors 152, and vehicle systems 158, in addition to or in replacement of other physical components illustrated in vehicle 100 of FIG. 1. Any of these components illustrated in FIG. 2 may electronically communicate with anomaly managing system 300, which is further described with FIG. 3.

Sensors 152 and vehicle systems 158 can communicate with anomaly managing client circuit 210 via a wired or wireless communication interface. Although sensors 152 and vehicle systems 158 are depicted as communicating with anomaly managing client circuit 210, they can also communicate with each other as well as with other vehicle systems. Anomaly managing client circuit 210 can be implemented as an ECU or as part of an ECU such as, for example electronic control unit 50 in FIG. 1. In other embodiments, anomaly managing client circuit 210 can be implemented independently of the ECU.

Anomaly managing client circuit 210, in this example, includes communication circuit 201, decision circuit 203 (including processor 206 and memory 208), and power supply (not shown). Components of anomaly managing client circuit 210 are illustrated as communicating with each other via a data bus, although other communication interfaces can be included.

Processor 206 can include one or more GPUs, CPUs, microprocessors, or any other suitable processing system. Processor 206 may include a single core or multicore processors. Memory 208 may include one or more various forms of memory or data storage (e.g., flash, RAM, etc.) that may be used to store the calibration parameters, images (analysis or historic), point parameters, instructions, and variables for processor 206 as well as any other suitable information. Memory 208, can be made up of one or more modules of one or more different types of memory, and may be configured to store data and other information as well as operational instructions that may be used by processor 206 to execute via anomaly managing client circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up anomaly managing client circuit 210.

Communication circuit 201 may comprise either or both wireless transceiver circuit 202 with antenna 208 and wired I/O interface 204 with an associated hardwired data port (not illustrated). As this example illustrates, communications with anomaly managing client circuit 210 can include either or both wired and wireless communications circuits 201. Wireless transceiver circuit 202 can include a transmitter and a receiver (not shown) to allow wireless communications via any of a number of communication protocols such as, for example, Wi-Fi®, Bluetooth®, near field communications (NFC), Zigbee®, and any of a number of other wireless communication protocols whether standardized, proprietary, open, point-to-point, networked or otherwise.

Antenna 208 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by anomaly managing client circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet® or any of a number of other wired communication protocols whether standardized, proprietary, open, point-to-point, networked or otherwise.

The power supply (incorporated with any of the features herein) can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 100, with which vehicle 200 is implemented. In the illustrated example, sensors 152 include vehicle acceleration sensors 212, vehicle speed sensors 214, wheelspin sensors 216 (e.g., one for each wheel), tire pressure monitoring system (TPMS) 220, accelerometers such as 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of vehicle 200.

In some examples, sensors 152 may also include one or more sensors that are operable to measure a roadway environment outside of vehicle 200. For example, sensors 152 may include one or more sensors that record one or more physical characteristics of the roadway environment that is proximate to vehicle 200.

In some examples, sensors 152 may also include one or more sensors that record an environment internal to a cabin of vehicle 200. For example, sensors 152 includes onboard sensors which monitor the environment of vehicle 200 whether internally or externally. In a further example, sensors 152 includes cameras, LIDAR, radars, infrared sensors, and sensors that observe the behavior of the driver such as internal cameras, biometric sensors, etc. In some examples, sensors 152 may include one or more of the following vehicle sensors: a camera; a LIDAR sensor; a radar sensor; a laser altimeter; an infrared detector; a motion detector; a thermostat; and a sound detector. Sensors 152 may also include one or more of the following sensors: a carbon monoxide sensor; a carbon dioxide sensor; an oxygen sensor; a mass air flow sensor; and an engine coolant temperature sensor. Sensors 152 may also include one or more of the following sensors: a throttle position sensor; a crank shaft position sensor; an automobile engine sensor; a valve timer; an air-fuel ratio meter; and a blind spot meter. Sensors 152 may also include one or more of the following sensors: a curb feeler; a defect detector; a Hall effect sensor, a manifold absolute pressure sensor; a parking sensor; a radar gun; a speedometer; and a speed sensor. Sensors 152 may also include one or more of the following sensors: a tire-pressure monitoring sensor; a torque sensor; a transmission fluid temperature sensor; and a turbine speed sensor (TSS); a variable reluctance sensor; and a vehicle speed sensor (VSS). Sensors 152 may also include one or more of the following sensors: a water sensor; a wheel speed sensor; and any other type of automotive sensor.

Sensors 152 may generate sensor data. For example, the sensor data may comprise digital data describing one or more sensor measurements of sensors 152. For example, the sensor data may include vehicle data describing vehicle 200 (e.g., GPS location data, speed data, heading data, etc.), driver, and other sensor data describing a roadway environment (e.g., camera data depicting a roadway or a vehicle's proximity to other vehicles, etc.).

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

During operation, anomaly managing client circuit 210 can receive information from various vehicle sensors to determine whether a remote operator should be ready to operate the vehicle by performing the driving operations, or be ready to assist the driver of a semi-autonomous vehicle with a limited driving situation from afar. Communication circuit 201 can be used to transmit and receive information between anomaly managing client circuit 210 and sensors 152, and anomaly managing client circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining to communicate with anomaly managing system 300, as described with FIG. 3. Additionally, communication circuit 201 can be used to send an activation signal or other activation information to various vehicle systems 158 as part of entering or exiting an anomaly detection and management mode, if applicable to the implemented embodiment.

FIG. 3 is a block diagram illustrating an architecture for anomaly managing system and anomaly managing client according to some embodiments. In this example, anomaly managing system 300 and anomaly managing client circuit 210 are provided. Anomaly managing system 300 may be installed in a server or cloud-based system and vehicle 350 may detect an occurrence of an anomaly as it is operating on a roadway. Vehicle 350 may be affected by the anomaly.

Anomaly managing system 300 may include software that is operable to manage an anomaly and anomaly-affected entities. In some embodiments, anomaly managing system 300 may be implemented using hardware including a field-programmable gate array (“FPGA”) or an application-specific integrated circuit (“ASIC”). In some other embodiments, anomaly managing system 300 may be implemented using a combination of hardware and software. Anomaly managing system 300 may be stored in a combination of the devices (e.g., servers or other devices), or in one of the devices.

Anomaly managing system 300 may communicate with ego vehicle 350 (e.g., connected vehicle) and other vehicles 310 via network 370. In some examples, other vehicles 310 may be autonomous vehicles (no passenger and/or driver) or non-autonomous vehicles in the vicinity of a vehicle exhibiting anomalous behavior (e.g., aggressive driving). Anomaly managing system 300 may provide route management instructions (e.g., determined by AI route planner 303) to vehicles 310 that causes them to drive to where the aggressive driver is located, create a barrier for the aggressive driver, and drive in formation to track the position of the aggressive driver so that the barrier is maintained and the dynamics of the aggressive driver are reduced. Reducing the dynamics of the aggressive driver includes, for example, making it harder for the aggressive driver to change lanes or speed up without causing a collision or some other negative consequence for the aggressive driver.

Network 370 may be a wired or wireless network, and may have numerous different configurations including a star configuration, token ring configuration, or other configurations. Furthermore, network 370 may include a local area network (LAN), a wide area network (WAN) (e.g., the Internet), or other interconnected data paths across which multiple devices and/or entities may communicate. In some embodiments, network 370 may include a peer-to-peer network.

Network 370 may be coupled to or may include portions of a telecommunications network for sending data in a variety of different communication protocols. In some embodiments, network 370 includes Bluetooth® communication networks or a cellular communications network for sending and receiving data including via short messaging service (SMS) and multimedia messaging service (MMS). In some embodiments, network 370 includes networks for hypertext transfer protocol (HTTP), direct data connection, wireless application protocol (WAP), e-mail, DSRC, full-duplex wireless communication and mmWave. In some embodiments, network 370 further includes networks for WiFi (infrastructure mode), WiFi (ad-hoc mode), visible light communication, TV white space communication and satellite communication. Network 370 may also include a mobile data network that may include 3G, 4G, LTE, LTE-V2X, LTE-D2D, VOLTE, 5G-V2X or any other mobile data network. Network 370 may also include any combination of mobile data networks. Further, network 370 may include one or more IEEE 802.11 wireless networks.

Vehicle 350 includes various components in addition to or in replacement of other physical components illustrated in vehicle 100 of FIG. 1 and vehicle 200 of FIG. 2. For example, besides the elements described above with reference to FIG. 2, vehicle 350 may include data storage 315, network interface 317, control database 345, vehicle manager 319, and anomaly detector 321, as described herein.

Anomaly detector 321 may include code and routines for detecting an occurrence of an anomaly in the roadway environment. For example, anomaly detector 321 may detect the occurrence of the anomaly by performing operations described in U.S. patent application Ser. No. 16/273,134, filed on Feb. 11, 2019, titled “Anomaly Mapping by Vehicular Micro Clouds,” the entirety of which is incorporated herein by reference.

Vehicle manager 319 may include code and routines for performing coordination with other vehicles 310 via V2X communications. For example, vehicle manager 319 may manage (e.g., establish and maintain) inter-vehicular wireless links and control executions of collaborative operations among vehicles 310.

Anomaly managing client circuit 210 of vehicle 350 may cause vehicle manager 319 to send sensor data recorded by vehicle 350 to anomaly managing system 300. The sensor data can be recorded by sensors 152 and forwarded to anomaly managing client circuit 210 and anomaly detector 321.

Anomaly managing client circuit 210 may also receive anomaly data describing the vehicle exhibiting anomalous behavior from anomaly detector 321. Anomaly managing client circuit 210 may send, via vehicle manager 319, the anomaly data to anomaly managing system 300.

Anomaly managing system 300 may comprise Artificial Intelligence (AI) manager 304, ASI database 341, and anomaly manager 306. AI manager 304, in some examples, may include AI mobility planner 301 and AI route planner 303.

AI mobility planner 301 is operable to continuously monitor mobility information of connected entities (e.g., vehicles) and store current route information and predicted route information of the connected entities. AI mobility planner 301 may generate the hierarchical AI data based at least on the current route information and predicted route information of the connected entities and any other information of the connected entities (e.g., speed data, heading data, etc.).

AI route planner 303 may be operable to plan routes for the connected entities based on the hierarchical AI data. In some embodiments, AI route planner 303 may assist anomaly manager 306 to plan routes for the anomaly-affected entities responsive to the occurrence of the anomaly.

Anomaly manager 306, in some examples, may include one or more of the following elements: anomaly mobility planner 305, AI interface 307, impact analyzer 309, and strategy generator 311.

Anomaly mobility planner 305 may be operable to monitor information of anomalies present in the roadway environment. This information may include, for example, location information, description information, and any other information related to the anomaly.

AI interface 307 may be operable to retrieve hierarchical AI data associated with the roadway environment from AI manager 304.

Impact analyzer 309 may be operable to determine an impact of the anomaly. Impact analyzer 309 may also determine an influence region of the anomaly based on one or more roadway condition parameters and the impact of the anomaly. Impact analyzer 309 determines a set of anomaly severity indices associated with a set of sub-regions within the influence region.

In some embodiments, the anomaly data and the set of anomaly severity indices are stored in ASI database 341.

Strategy generator 311 may be operable to manage anomaly-affected entities within the influence region based on the set of anomaly severity indices. For example, for each sub-region from the set of sub-regions, strategy generator 311 identifies, one or more anomaly-affected entities within the sub-region. Strategy generator 311 generates a corresponding control strategy to manage the one or more anomaly-affected entities in the sub-region based on a corresponding anomaly severity index associated with the sub-region. Strategy generator 311 instructs the one or more anomaly-affected entities in the sub-region to execute the corresponding control strategy. As a result, strategy generator 311 generates a set of control strategy to manage anomaly-affected entities in the influence region based on the set of anomaly severity indices.

For example, with respect to vehicle 350 which is affected by the anomaly, strategy generator 311 identifies that vehicle 350 is present within a particular sub-region that is associated with a particular anomaly severity index. Strategy generator 311 generates a control strategy for vehicle 350 based on the particular anomaly severity index. Strategy generator 311 sends strategy data describing the control strategy to vehicle 350. After receiving the strategy data, anomaly managing client circuit 210 of vehicle 350 may store the strategy data in control database 345. Anomaly managing client circuit 210 may inform vehicle manager 319 about the received strategy data. Anomaly managing client circuit 210 ensures that vehicle manager 319 follows the control strategy described by the strategy data so that vehicle 350 operates in accordance with the control strategy to mitigate an effect of the anomaly. For example, assume that the control strategy instructs vehicle 350 to change a lane immediately. Then, vehicle manager 319 can modify an operation of an ADAS system of vehicle 350 so that the ADAS system controls vehicle 350 to change its lane immediately.

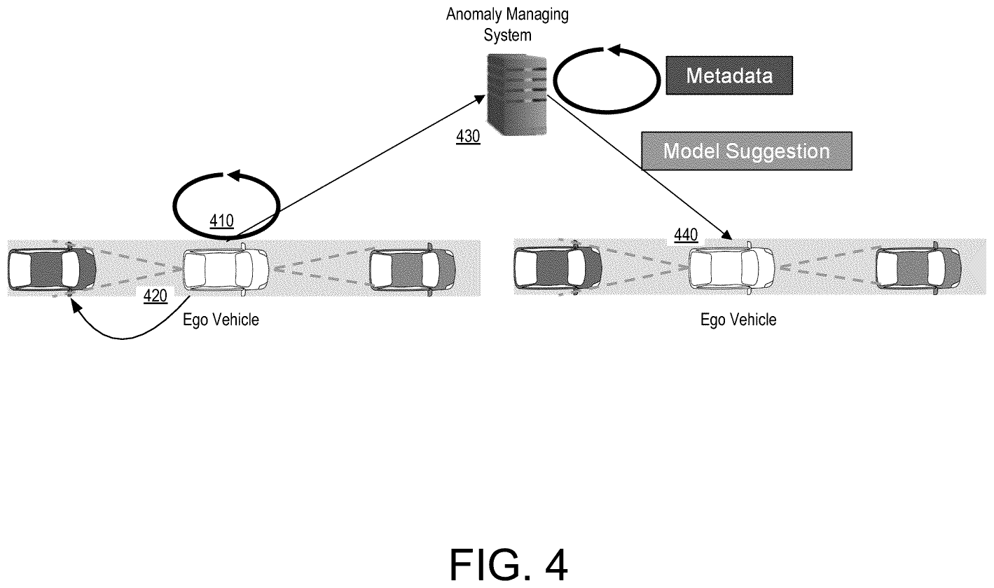

FIG. 4 is a graphical representation of an example approach of model selection according to some embodiments. In some examples, the process may be implemented at anomaly managing system 300 of FIG. 3 and the ego vehicle may correspond with vehicle 100 of FIG. 1, vehicle 200 of FIG. 2, or vehicle 350 of FIG. 3.

At block 410, the ego vehicle may collect data of its surroundings, including driving data from the ego vehicle, second vehicle, or other infrastructure elements, or data characterizing the relationship between any of these elements. The driving data from multiple sources may be combined to generate aggregated driving data. Various types of vehicle data are collected including, but not limited to, instrumentation data, logging data, sensor data, or any other type of data. For example, the front radar can measure the distance to the preceding vehicle from the ego vehicle. Leveraging images of the backup camera with monocular depth estimation technology can determine the spacing to the follower vehicles.

At block 420, the ego vehicle may receive driving data from the second vehicle. The driving data may be received using various methods. If the second vehicle is a connected vehicle, the second vehicle may provide data to the ego vehicle through the temporary network (e.g., the status of the driver of the second vehicle using sensor data internal or external to the second vehicle). The second vehicle can use internal sensors (e.g., in-cabin camera, gas/brake pedal positions, etc.) and conclude about its driver is either abnormal or not. Similarly, the second vehicle may construct data (e.g., metadata) about its conclusion that can be transmitted via the network to the anomaly managing system.

In generating a temporary network, the ego vehicle may comprise an onboard unit that enables various types of Vehicle-to-Anything or “V2X” radios and is operable to send and receive various types of V2X messages. For example, the ego vehicle includes one or more V2X radios having channels that are operable to send or receive one or more of the following types of V2X messages: Institute of Electrical and Electronics Engineers (IEEE) 802.11p (802.11p); Dedicated Short-Range Communication (DSRC); Long-Term Evolution (LTE); wireless fidelity (WiFi); and millimeter wave (mmWave); 3G; 4G; 5G; LTE-Vehicle-to-Anything (LTE-V2X); LTE-Vehicle-to-Vehicle (LTE-V2V); LTE-Device-to-Device (LTE-D2D); 5G-V2X; Intelligent Transportation System-G5 (ITS-G5); ITS-Connect; Voice over LTE (VOLTE); television (TV) white space and any derivative or fork of one or more of the V2X communication protocols listed here.

As used herein, “802.11p” refers to V2X messages that are compliant with the IEEE 802.11p amendment to the IEEE 802.11 standard for sending and receiving wireless messages by a connected vehicle or a connected roadway infrastructure device such as a roadside unit (“RSU” if singular, “RSUs” if plural).

If the second vehicle is not a connected vehicle, the ego vehicle may receive data from the anomaly managing system via the V2X communication network (e.g., Vehicle-to-Vehicle (V2V), Vehicle-to-Infrastructure (V21), Vehicle-to-Cloud (V2C), etc.). In some examples, the ego vehicle may temporarily connect to the V2X communication network to determine information about other vehicles in the environment. Additional detail on V2X communication networks are discussed in U.S. Pat. No. 10,789,848, which is incorporated by reference herein in its entirety.

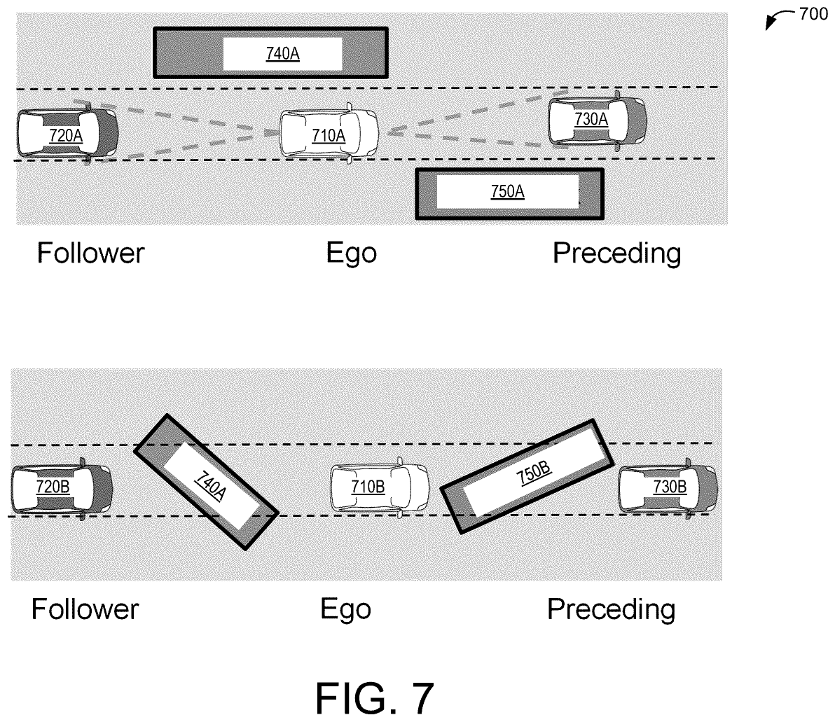

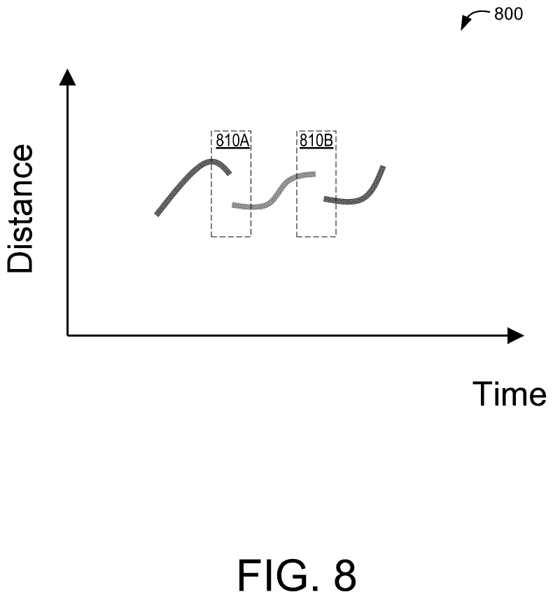

The driving data may be redundant of the driving data that the ego vehicle receives from sensors of the ego vehicle. In some examples, the driving data may be second driving data that fills in gaps in the first driving data. Additional information on filling in the gaps in the driving data is discussed with FIGS. 7 and 8.

When implementing a temporary network between the ego vehicle and the second vehicle, various communications may be transmitted between the vehicles. For example, after the temporary network is generated between the ego vehicle and a second vehicle, the ego vehicle may transmit a request to the second vehicle in a message format corresponding with the generated temporary network (e.g., Wi-Fi®, Bluetooth®, NFC, etc.). The request may identify the gaps in the time-series data entries and request driving data from the second vehicle to fill in the gaps. The driving data from the second vehicle may be aggregated with the driving data stored by the ego vehicle to continue with the data analysis.

Using the data, the ego vehicle may associate a model of abnormal driving detection associated with the predicted movements performed by the second vehicle, The model may help define a pattern of predicted operations (e.g., the movement profile) to each of the other vehicles. Each movement profile may characterize the vehicles on the roadway, and rely on the determined model to predict each vehicle's future driving behaviors or distinctive movement patterns. The movement patterns may include abnormal driving behaviors or normal driving behaviors, when the predicted movements are compared to other vehicles in the environment (e.g., that are operating within a threshold level of safety). The movements of the vehicles that correspond within a threshold value of the predicted movements determined by the model of abnormal driving detection, may be assigned the movement profile to the particular vehicle.

In some examples, the anomaly managing system should suggest the model according to first driving data and second driving data. The model could be time series analysis based detection or it could correspond with a trained machine learning model.

At block 430, the ego vehicle may generate metadata to send to the anomaly managing system, or the ego vehicle may transmit first driving data or second driving data to the anomaly managing system. The anomaly managing system can suggest the model according to the metadata, first driving data, or second driving data. In some examples, the suggested model may include a time series analysis-based detection or a trained machine learning model.

When metadata is transmitted to the anomaly managing system, metadata may include, for example, driving data (e.g., generated by sensors of the ego vehicle or second vehicle), a set of parameters (e.g., distance-to-collision, speed, location, time-of-day, or other contextual features, noise level, quality of the data, entropy of the data, or other data features) used in the abnormal driving detection, a set of sensors (e.g., camera, radar) used to measure the parameters of the subject vehicle, and the movement profile assigned to the vehicle. In some examples, the metadata is a subset of driving data.

In some examples, the metadata may include a type of algorithm (e.g., time-series analysis, machine learning) associated with the movement profile assigned to the other vehicle. The algorithm may analyze the parameters or other sensor data locally at the ego vehicle to determine additional metadata to send to the anomaly managing system.

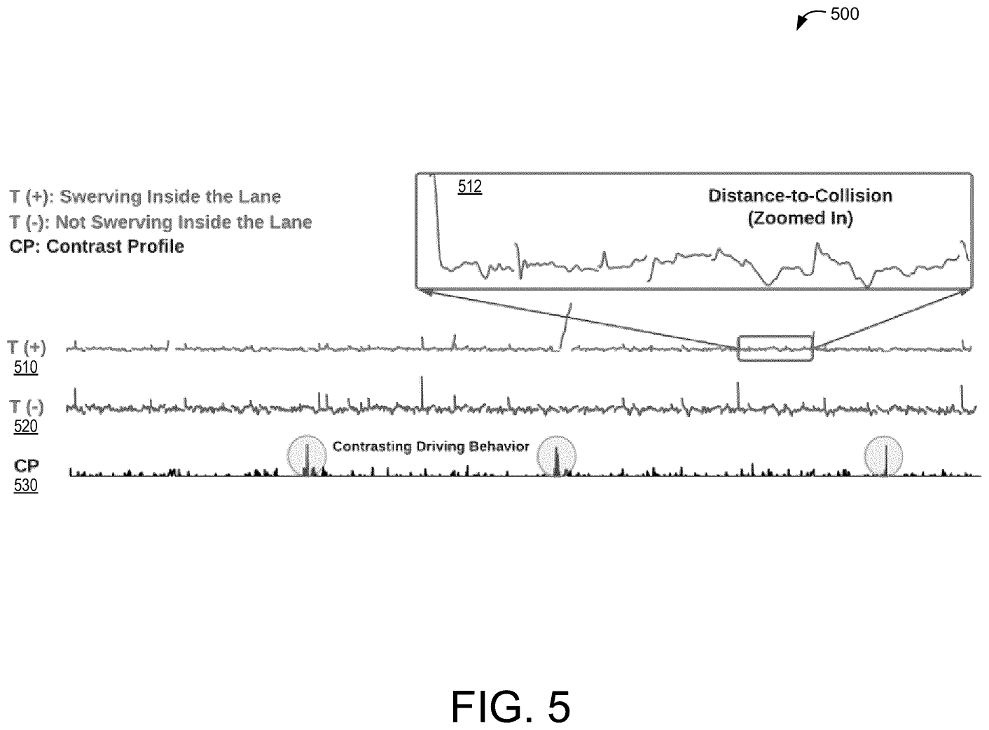

In some examples, the metadata may be incomplete and the movement profile defining a pattern of predicted operations may be undefined from the driving data. Additional information associated with incomplete metadata is provided with FIG. 5-8.

As an illustrative example, the second vehicle may be following the ego vehicle too closely. The metadata generated by the ego vehicle (e.g., to respond to the operations of the second vehicle) may include, for example, a parameter value corresponding with the distance between the two vehicles, a sensor value corresponding with a camera or other image sensor, and an algorithm value corresponding with a trained machine learning model to detect the abnormal driving. In other examples, the metadata may correspond with input to provide to a time series analysis or pattern matching analysis, either of which may be used by the anomaly managing system as the input data to generate the analysis.

The anomaly managing system can receive the metadata from the vehicles (e.g., the ego vehicle or the second vehicle) using the V2X communication network. In some examples, the anomaly managing system can communicate with the vehicles and request data directly. In some examples, the transmitted data may be transformed via, e.g., data cleaning and data preparation, etc. Some systems that process and detect abnormal driving using anomaly detection are discussed in U.S. Pat. Nos. 11,380,198 and 11,414,088 and U.S. patent application Ser. No. 17/959,773, which are incorporated by reference herein in their entirety.

At block 440, the model suggestion may be transmitted to ego vehicle, or in some examples, the ego vehicle may generate the model suggestion locally. The ego vehicle may incorporate the model with its automated driving operations or operator-assisted driving operations to respond to the detected abnormal driving behavior and improve roadway safety.

As an illustrative example, the model may suggest collecting observations of the environment. This may instruct the driving data and sensor data collection to adjust data gathering. For example, instead of distance-to-collision, the vehicle systems may collect speed data and use it to determine the particular movement profile to select for the second vehicle or instruct the ego vehicle how to respond to the second vehicle's movements.

FIG. 5 is a graphical representation illustrating movement patterns or movement profiles according to some embodiments. Movement patterns or movement profiles may be discussed interchangeably herein.

As discussed with FIG. 4, the ego vehicle may use the driving data to determine a movement profile of the second vehicle. The operations performed by the second vehicle may be compared to a set of previously-stored movement profiles to determine which movement profile is most similar to the movements performed by the second vehicle. The movements of the second vehicle that exceed a threshold value to a particular movement profile may identify the predicted movements that are likely to be performed by the second vehicle.

In illustration 500, movement profiles are illustrated as first movement profile 510 and second movement profile 520, with a detailed portion 512 of first movement profile 510. The movement profiles may be generated to cluster distinctive movement patterns of vehicles that perform similar movements in a time-series data format on the roadway. The anomaly managing system may generate and store a plurality of movement profiles from the data. In illustration 500, the movement profiles include swerving and not swerving inside the lane. These two species are compared with the driving data received from the ego vehicle by the anomaly managing system and performs time-series analysis to infer the longitudinal movement patterns unique to type of movement patterns. The contrasting driving behavior between the two movement profiles is determined as contrast profile 530.

In some examples, contrast profile 530 can be learned through a time series analysis. For example, time series T=t1, t2, . . . , tn is a sequence of real-valued numbers and a subsequence Ti,m is a contiguous subset of values from T starting at index i with length m. In determining contrast profile 530, the system may score subsequences with a new piece of metadata that reflects the property that a subsequence is simultaneously close to its nearest neighbor in some data, but far from its nearest neighbor in other data. The property may be stored as a vector of values identifying contrast profile 530.

In some examples, a set of contrast profiles may be determined based on location-specific factors, time-specific factors, or other environmental characteristics. The set of contrast profiles may be compared with the driving data to determine predicted movements of vehicles that are matched to the movement profile in excess of the threshold value.

In illustration 500, first movement profile 510 and second movement profile 520 are shown as two time-series datasets, T (+) and T (−), by concatenating the distance-to-collision driving data of swerving and not swerving drivers. Contrast profile 530 corresponds with the differences between first movement profile 510, or T (+), and second movement profile 520, or T (−). The distinctive portions are illustrated as a spike in contrast profile 530 when the time series driving data has contrasting behavior. When first movement profile 510 and second movement profile 520 contrast each other, the anomaly managing system records the movement pattern, which may be accumulated based on location, time of day, or other characteristics of the environment.

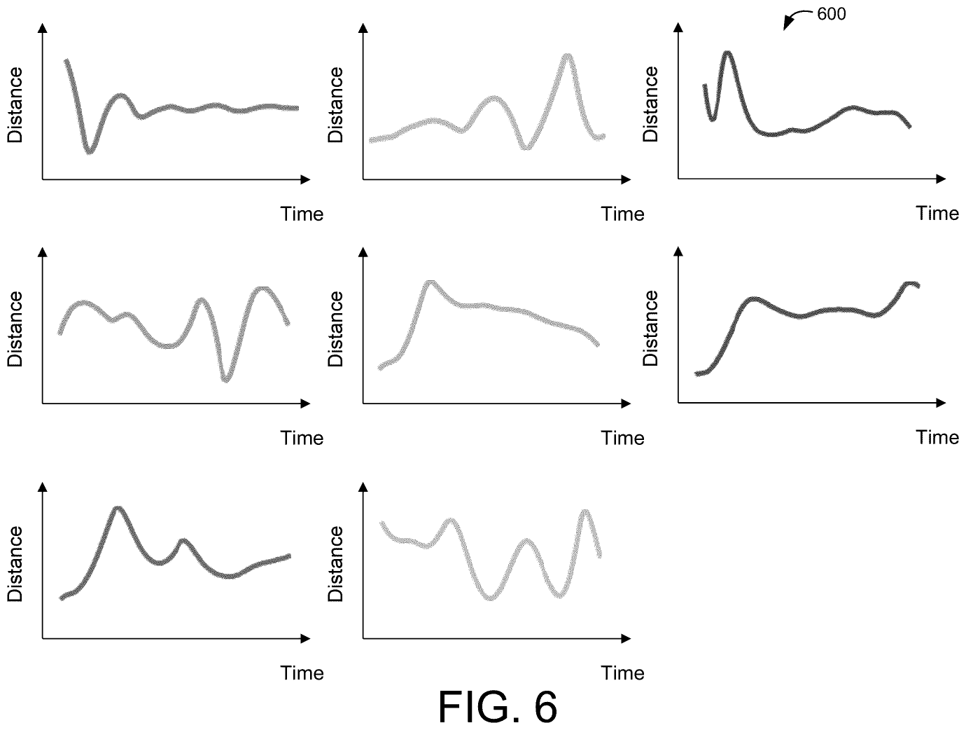

Examples of movement profiles or models of abnormal driving behavior are further illustrated in FIG. 6. In illustration 600, various sets of 10 second longitudinal movement patterns are used to generate each movement profile or model of abnormal driving behavior provided. At least some of the longitudinal movement patterns may be unique to distracted driving or other types of abnormal driving. When drivers get distracted (i.e., swerve inside the lane), they may also exhibit fluctuating distance-to-collision (i.e., having a short spacing to the preceding vehicle followed by a large one or vice versa). In some examples, lateral movement patterns may be determined and recognized as well. By determining the movement patterns and comparing them with the driving data from ego vehicle, the anomaly managing system can early and accurate detection of distracted driving.

In some examples, the contrast profile can learn various movement patterns. For example, the system can determine a movement pattern of a duration of n-seconds (e.g., 5 second movement pattern unique to distracted driving or 10 seconds movement patterns). The pattern recognition algorithm can compare similarities between the observed pattern and a stored or inferred movement pattern.

FIG. 7 is a graphical representation illustrating gaps in driving data according to some embodiments. In illustration 700, ego vehicle 710 collects driving data about the other vehicles (e.g., follower vehicle 720, preceding vehicle 730, or other second vehicles in the environment). The driving data collection of ego vehicle 710 is interrupted due to lane change movements behavior of other larger vehicles (e.g., large follower vehicle 740, large preceding vehicle 750, or other large third vehicles in the environment).

In this example, at a first time, ego vehicle 710A collects driving data about follower vehicle 720A and preceding vehicle 730A. The driving data collection of ego vehicle 710A is collected when ego vehicle 710A has a line-of-sight observation of follower vehicle 720A and preceding vehicle 730A. When large vehicles 740B, 750B interrupt the line-of-sight between ego vehicle 710B and vehicles 720B, 730B at a second time, the driving data collection is interrupted as well due to lane change movements of large follower vehicle 740B and large preceding vehicle 750B.

In some examples, the line-of-sight observations are used to generate driving data as time-series data entries of movements performed by other vehicles in the environment. When the observations of the vehicles that are used to generate the time-series data entries is interrupted, a gap in the time-series data entries is generated. In traditional systems, abnormal driving cannot be detected through time-series analysis-based methods because the collected driving data does not provide enough data for the system to infer movement patterns. Some movement profiles may need consecutive driving data collection. In this example, ego vehicle 710B may be unable to determine the movement profile of follower vehicle 720B based on movements of large follower vehicle 740B, or unable to determine the movement profile of preceding vehicle 730B based on movements of large preceding vehicle 750B.

FIG. 8 is a graphical representation illustrating gaps 810 in driving data that can affect selection of an abnormal driving detection model based on movement patterns according to some embodiments.

Second driving data may be received to fill in gaps 810 using various methods. For example, ego vehicle may sense the driving environment and construct a small subset of driving data as second driving data. To sense the driving environment, the ego vehicle may rely on sensors or vehicle systems discussed herein, including the GPS or other vehicle positioning system 272 in FIG. 2, to identify average time-series data entries for the location or time of day. The ego vehicle may use the average time-series data entries as the second driving data.

In some examples, the metadata may be analyzed at the ego vehicle using a trained machine learning model with second driving data as output. The generated second driving data is a predicted movement of the second vehicle based on observed movements. The second driving data is used to fill in the gaps in the movement profile. In this example, ego vehicle uses the trained machine learning model to generate the second driving data that fills in the gaps in the time-series data entries, rather than a complete time-series based analysis of the movement of the second vehicle corresponding with a particular movement profile.

In another example, ego vehicle can share the received/observed driving data or metadata with the anomaly managing system and the anomaly managing system analyzes the metadata. The anomaly managing system may analyze the metadata and suggest a model to detect abnormal driving for the ego vehicle. Since the driving data by the ego vehicle is interrupted, the anomaly managing system may implement the trained machine learning model remotely from the ego vehicle with second driving data as output. The anomaly managing system may transmit the model to detect abnormal driving to the ego vehicle, which it can use to execute an algorithm to provide driving assistance to respond to the predicted movements defined in the movement profile.

In some examples, the anomaly managing system can store a history of incremental uses or the count totaling each use of each particular movement profile. Based on the history, the anomaly managing system can determine which movement profile is identified most often for the location or time of day.

In some examples, the movement profile may be associated with a success rate. For example, the anomaly managing system may provide a suggested movement profile to the ego vehicle and the operator of the vehicle may provide feedback to the anomaly managing system (e.g., via a display associated with the ego vehicle). The suggested movement profile may correspond with a time-series-based analysis that generates an abnormal driving notification, but the operator may conclude that the notification is a false alarm and reject the notification. The success rate of the movement profile may be decreased in this instance. In another example, the suggested movement profile may correspond with a machine-learning-based analysis that generates an abnormal driving notification, and the operator may conclude that the notification is a true alarm and accept the generated control suggestion. The success rate of the movement profile may be increased in this instance.

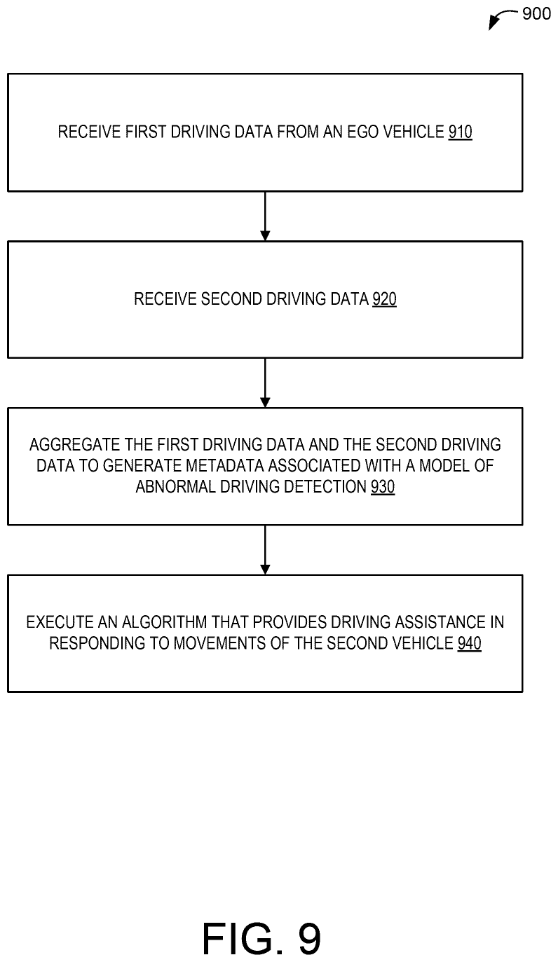

FIG. 9 illustrates a process for programmatically updating pattern recognition leading to abnormal driving detection in accordance with some embodiments of the systems and methods described herein. Method 900 may use each system described herein in the implementation of abnormal driving detection, including any of the components illustrated in FIG. 2 to electronically communicate with anomaly managing system 300 in FIG. 3.

At step 910, first driving data may be received from a sensor of ego vehicle. Driving data may be received from multiple sources, including instrumentation data, logging data, sensor data, or any other type of data. For example, the front radar can measure the distance to the preceding vehicle from the ego vehicle. Leveraging images of the backup camera with monocular depth estimation technology can determine the spacing to the follower vehicles.

In some examples, the collection of the first driving data may be interrupted due to lane change driving behavior of another long/large vehicle (or other obstruction), causing gaps in the time-series data entries collected by the ego vehicle, which may require consecutive collection of driving data. With the gaps in the first driving data, the ego vehicle may be unable to collect a threshold amount of driving data to provide to the system to select a model of abnormal driving behavior that can interpret, predict future movements of the second vehicle, and respond to its operations.

At step 920, second driving data may be received. For example, the ego vehicle may sense the driving environment and construct second driving data locally, receive second driving data from a follower vehicle or preceding vehicle via a temporary network (e.g., peer-to-peer or vehicle-to-anything network), or receive second driving data from a remote server to fill in gaps in the time-series data entries. In some examples, first driving data is analyzed at the ego vehicle using a trained machine learning model to determine a predicted movement of the second vehicle corresponding with abnormal driving detection of a particular movement profile. In this example, ego vehicle uses the trained machine learning model to generate the second driving data that fills in the gaps in the time-series data entries, rather than a complete time-series based analysis of the movement of the second vehicle.

In another example, the ego vehicle can share the received/observed driving data or metadata with the anomaly managing system and the anomaly managing system analyzes the metadata. The metadata may correspond to a summarized and shortened form of the driving data, so that less data is transmitted via the network. For example, metadata may include driving data (e.g., generated by sensors of the ego vehicle or second vehicle), a set of parameters used in the abnormal driving detection (e.g., distance-to-collision, following distance, speed, etc.), a set of sensors used to measure the parameters of the subject vehicle (e.g., camera, lidar, radar, etc.), inferred or limited characteristics of a particular movement pattern, or the movement profile assigned to the vehicle.

At step 930, the first driving data and the second driving data may be aggregated to generate metadata. The metadata may be associated with a model of abnormal driving detection. For example, using the metadata, the system can generate a suggestion for a trained machine learning model for the ego vehicle, where the model is used to predict the movement profile of other vehicles that may be operating abnormally. The abnormal operations of the other vehicles may correspond with abnormal driving (e.g., that follow driving patterns that has been detected previously) or movement profiles that can be identified using the model of abnormal driving detection. Since the driving data by the ego vehicle is interrupted, the system may implement the suggested model remotely from the ego vehicle with second driving data as output. In some examples, the system may transmit the model of abnormal driving detection to the ego vehicle.

At step 940, an algorithm may be executed that provides driving assistance in responding to movements of the second vehicle using the model of abnormal driving detection. For example, the ego vehicle can use the model to execute an algorithm to provide driving assistance to respond to the predicted movements defined in the movement profile. During operation, the ego vehicle can receive information from various vehicle sensors to determine whether a remote operator should be ready to operate the vehicle by performing the driving operations, or be ready to assist the driver of a semi-autonomous vehicle with a limited driving situation from afar.

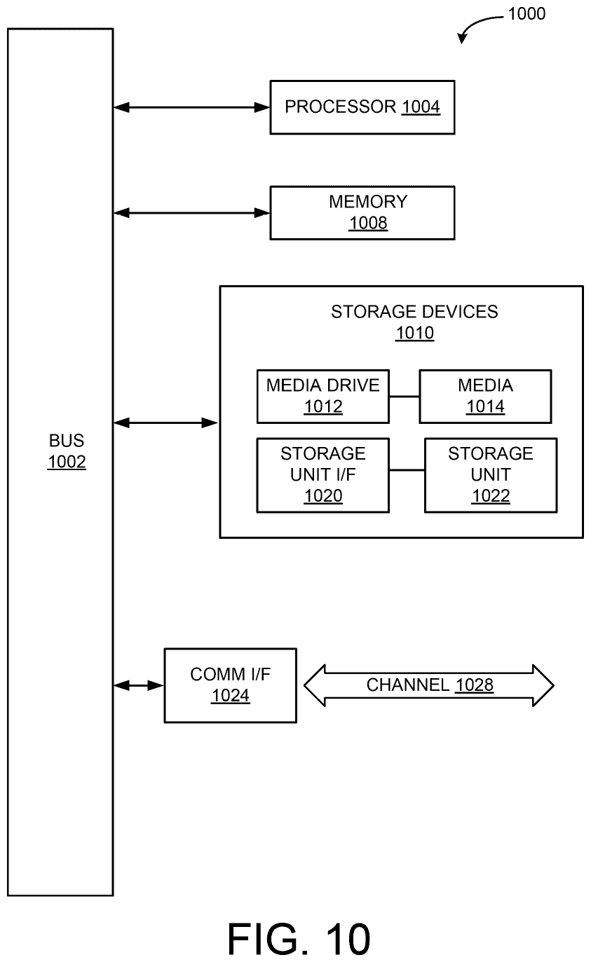

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. This can include a processor, and/or any one or more of the components making up vehicle 100 of FIG. 1, vehicle 200 of FIG. 2, or vehicle 350 or anomaly managing system 300 of FIG. 3. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

Computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An ego vehicle for programmatically determining an abnormal driving performed by a second vehicle, the ego vehicle comprising:
a memory; and
a processor that is configured to execute machine readable instructions stored in the memory to:
receive first driving data from a sensor of the ego vehicle, the first driving data comprising a gap in time-series data entries of movements of the second vehicle;
receive second driving data that fills in the gap in the time-series data entries of the second vehicle;
aggregate the first driving data with the second driving data to aggregated driving data to generate metadata, the aggregated driving data comprising movements of the second vehicle that exceed a threshold value of predicted movements defined in a model of abnormal driving detection, and the metadata used to select the model of abnormal driving detection; and
execute an algorithm that provides driving assistance for the ego vehicle in responding to the predicted movements defined in the model of abnormal driving detection.

2. The ego vehicle of claim 1, wherein the algorithm is applied intermittently to detect abnormal driving using the model of abnormal driving detection.

3. The ego vehicle of claim 1, wherein the second driving data is received by the ego vehicle by generating a temporary network between the ego vehicle and the second vehicle, and the temporary network is a peer-to-peer network between the ego vehicle and the second vehicle.

4. The ego vehicle of claim 1, wherein the second driving data is received by the ego vehicle by generating a temporary network between the ego vehicle and the second vehicle, and the temporary network is a Vehicle-To-Vehicle (V2V) network.

5. The ego vehicle of claim 1, wherein the gap in the time-series data entries of movements of the second vehicle is determined using metadata generated by the ego vehicle.

6. The ego vehicle of claim 1, wherein the processor is further configured to:
receive the model of abnormal driving detection from a cloud-based anomaly managing system that generates the model of abnormal driving detection using a trained machine learning model.

7. The ego vehicle of claim 1, wherein the processor is further configured to:
receive the model of abnormal driving detection from a cloud-based anomaly managing system that generates the model of abnormal driving detection using a time series analysis or pattern matching.

8. The ego vehicle of claim 1, wherein the first driving data includes a geographic location of the ego vehicle and the second vehicle.

9. The ego vehicle of claim 1, wherein the model of abnormal driving detection is determined by identifying reoccurring and repeated abnormal driving behavior that has been previously reported.

10. The ego vehicle of claim 1, wherein the processor is further configured to:
transmit the first driving data and the second driving data to a cloud-based anomaly managing system, wherein the cloud-based anomaly managing system uses the first driving data and the second driving data to update driving conditions for other vehicles.

11. The ego vehicle of claim 10, wherein the processor is further configured to:
distribute identification of the second vehicle to the other vehicles.

12. A method comprising:
receiving first driving data from a sensor of the ego vehicle, the first driving data comprising a gap in time-series data entries of movements of the second vehicle;
receiving second driving data that fills in the gap in the time-series data entries of the second vehicle;
aggregating the first driving data with the second driving data to aggregated driving data to generate metadata, the aggregated driving data comprising movements of the second vehicle that exceed a threshold value of predicted movements defined in a model of abnormal driving detection, and the metadata used to select the model of abnormal driving detection; and
executing an algorithm that provides driving assistance for the ego vehicle in responding to the predicted movements defined in the model of abnormal driving detection.

13. The method of claim 12, wherein the algorithm is applied intermittently to detect abnormal driving using the model of abnormal driving detection.

14. The method of claim 12, wherein the second driving data is received by the ego vehicle by generating a temporary network between the ego vehicle and the second vehicle, and the temporary network is a peer-to-peer network between the ego vehicle and the second vehicle.

15. The method of claim 12, wherein the second driving data is received by the ego vehicle by generating a temporary network between the ego vehicle and the second vehicle, and the temporary network is a Vehicle-To-Vehicle (V2V) network.

16. The method of claim 12, wherein the gap in the time-series data entries of movements of the second vehicle is determined using metadata generated by the ego vehicle.

17. The method of claim 12, further comprising:
receiving the model of abnormal driving detection from a cloud-based anomaly managing system that generates the model of abnormal driving detection using a trained machine learning model.

18. The method of claim 12, further comprising:
receiving the model of abnormal driving detection from a cloud-based anomaly managing system that generates the model of abnormal driving detection using a time series analysis or pattern matching.

19. The method of claim 12, wherein the first driving data includes a geographic location of the ego vehicle and the second vehicle.

20. The method of claim 12, wherein the model of abnormal driving detection is determined by identifying reoccurring and repeated abnormal driving behavior that has been previously reported.
